(19) United States
(12) Patent Application Publication
(10) Pub. No.: US 2012/0231780 A1
(43) Pub. Date: Sep. 13, 2012

(54) Method for Cellular Telephone Adaptation and Mobile Communication System

(76) Inventors: Yakov Kharon, Moscow (RU); Roman Rozenberg, Brooklyn, NY (US)

(21) Appl. No.: 13/044,092

(22) Filed: Mar. 9, 2011

(51) Int. Cl. H04W 4/00

(52) U.S. Cl. 455/419

(57) ABSTRACT

A method for adapting a mobile communications device equipped with a Subscriber Identification Module (SIM) card reader includes inserting an additional integrated circuit in the mobile communications device on a substrate having a contact interface connectable to the mobile communications device. A request for additional software is transmitted from the mobile communication device to a mobile communication server using programming preinstalled on the additional integrated circuit. One or more message containing additional software for use by the additional integrated circuit are received in response to the request. Installing the received additional software within the mobile communications device or the additional integrated circuit.

### BACKGROUND OF THE INVENTION

1. Technical Field

The present disclosure relates to cellular telephones and, more specifically, to a method for cellular telephone adaptation and a mobile communication system.

2. Discussion of Related Art

Mobile phones have been developed to accommodate multiple Subscriber Identity Modules (SIMs). A SIM is a removable card that stores the service-subscriber key (IMSI) used to identify a subscriber on a cellular phone or other mobile devices. In cellular telephone networks such as those that utilize the GSM standards, the SIM may be embodied on a smart card such as the UICC (Universal Integrated Circuit Card). In other telephone networks such as those that utilize the UMTS standards, it is a Universal Subscriber Identity Module (USIM) application that is installed on the UICC.

By accommodating multiple SIM cards, a single telephone may make and receive calls from two distinct telephone numbers, and perhaps, using multiple different network carriers.

One such method is described in greater detail for example in the U.S. Pat. No. 6,603,982 of Aug. 5, 2011, which is incorporated herein by reference. U.S. Pat. No. 7,303,137 of Dec. 4, 2007, which is also incorporated herein by reference, relates to a dual card system for portable device. “The dual card system includes a first card having a first substrate and a first integrated circuit (IC) provided with a first plurality of contacts on a top surface of the first substrate, and a second card having a second substrate and a second IC provided with a second plurality of contacts on a top surface of the second substrate. The second substrate is provided with a first plurality of pins on a bottom surface thereof, to be electrically coupled with the first plurality of contacts, respectively.”

WO 2007/081382 of Jul. 19, 2007, which is also incorporated herein by reference, relates to a method for providing additional service based on dual UICC. U.S. Pat. No. 6,775,725 of Aug. 10, 2004, which is also incorporated herein by reference, explains, “to execute a program in a second chip card, inserted in a terminal in addition to a first chip card, containing data relating to the owner of the first card, the second card communicates with terminal through exchanges of commands and responses between the two cards, relayed through exchanges of commands and responses between the first card and the terminal. For example, the terminal is a mobile radio telephone terminal with a SIM card as a first card, not requiring any SIM Toolkit protocol interface between the terminal and the second card. Compatibility and adaptation of the second card to the terminal is provided in the preparation for the execution of the program.” U.S. Pat. No. 6,775,725 of Aug. 10, 2004, which is also incorporated herein by reference, relates to a method for preparing a mobile telephone for performing new functions (applications) enabled when the telephone is accessed by the user to offer a menu of additional applications, including inserting an additional integrated circuit in the telephone on a substrate having a contact interface connectable to the telephone, and subsequently adapting the additional integrated circuit in the telephone by downloading and installing additional software.

Such techniques as those mentioned above rely upon additional software being transferred to the additional integrated circuit from the SIM card used in the telephone. As a result, the use of the additional integrated circuit is constrained because it has to be combined with special SIM cards compatible with it.

U.S. Pat. No. 6,775,725 of Aug. 10, 2004, which is also incorporated herein by reference, relates to a mobile communications system in which mobile telephones equipped with SIM cards are provided with an additional integrated circuit on a substrate that has a contact interface connected to the telephone.

Such a technique constrains the use of an additional integrated circuit that can only be used with SIM cards adapted for exchanging information with the additional integrated circuit.

### SUMMARY

A method for adapting a mobile communications device equipped with a Subscriber Identification Module (SIM) card reader includes inserting an additional integrated circuit in the mobile communications device on a substrate having a contact interface connectable to the mobile communications device. A request for additional software is transmitted from the mobile communication device to a mobile communication server using programming preinstalled on the additional integrated circuit. One or more message containing additional software for use by the additional integrated circuit are received in response to the request. Installing the received additional software within the mobile communications device or the additional integrated circuit.

The mobile communications device may be a mobile telephone. Alternatively, the mobile communications device may be a portable computer, a smartphone, a personal digital assistant (PDA), a tablet computer, a portable media player (PMP), or a wireless modem.

The request for additional software sent from the mobile communications device to the mobile communications server may include one or more messages which include SMS messages, GPRS messages, USSD messages, or multimedia messaging service messages (MMS). The one or more message containing additional software for use by the additional integrated circuit may include SMS messages, GPRS messages, USSD messages, or multimedia messaging service messages (MMS).

The additional software for use by the additional integrated circuit may include an application.

The SIM card reader may be a card slot for receiving a SIM card, a Universal Integrated Circuit Card (UICC) containing a Universal Subscriber Identity Module (USIM), a Removable User Identity Module (R-UIM) card, or a PIM card.

A method for adapting a mobile communications device equipped with a SIM card reader includes executing instructions preinstalled on an additional integrated circuit integrated into the mobile communications device for generating and transmitting a request for additional software from a remote server. Additional software is received and installed from the remote server in response to the request. The additional software is received in the form of one or more messages.

The additional integrated circuit may be removable from the mobile communications device. The mobile communications device may be a mobile telephone. Alternatively, the mobile communications device may be a portable computer, a smartphone, a personal digital assistant (PDA), a tablet computer, a portable media player (PMP), or a wireless modem.

The remote server may send the one or more messages containing the additional software to the mobile communications device upon receipt of the request from the mobile communications device. The request for additional software sent from the mobile communications device to the mobile communications server and the one or more message containing the additional software each may include one or more SMS messages, GPRS messages, USSD messages, or multimedia messaging service (MMS) messages.

A mobile communications system includes one or more mobile communications devices, each equipped with a SIM card reader and provided with an additional integrated circuit on a substrate having a contact interface connected to the mobile communications device via the SIM card reader. The additional integrated circuit includes a slot for receiving a SIM card therein. A server is configured to prepare and send messages containing additional software to the mobile communications devices to be downloaded and installed to the additional integrated circuit of the mobile communications devices. The additional integrated circuit is configured to enable the mobile communications devices to download and install the additional software sent from the server and contained in the messages.

The mobile communications device may be a mobile telephone, a portable computer, a smartphone, a personal digital assistant (PDA), a tablet computer, a portable media player (PMP), or a wireless modem.

The server may be configured to receive a message with a request from the mobile communications devices and to send a message containing the additional software to the mobile communications devices that have sent the request. The additional integrated circuit may be capable of preparing a message to be sent by the mobile communications devices to the server.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a diagrammatic view of a mobile communications system enabled to adapt a mobile telephone according to an exemplary embodiment of the present invention; and

FIG. 2 is a flow chart illustrating an approach for adapting a mobile phone according to an exemplary embodiment of the present invention.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention relate to a method for adapting a mobile telephone such as those equipped with a subscriber identification card such as a SIM card, a USIM card, a Removable User Identity Module (R-UIM) card, and/or PIM card. Software may be installed on an additional integrated circuit (IC). The additional IC may then be inserted into a telephone on a substrate having a contact interface connectable to the telephone. One or more SIM cards may then be connected to the telephone through the additional IC. The additional integrated circuit may use preinstalled software and after the additional IC has been connected to the telephone, the software preinstalled on the additional IC may be used to prepare a request to a server for the downloading of additional software. The additional integrated circuit may initiate transmission of the request to the server, for example, by way of message such as those conforming to Short Message Service (SMS), General packet radio service (GPRS), and/or Unstructured Supplementary Service Data (USSD) standards.

The server may accordingly send, in response to the request, one or more messages containing additional software for the additional integrated circuit. The additional IC may then download and install the additional software. The server may then send messages containing additional software for the additional integrated circuit, for example, in accordance with its own program or on the operator's instructions.

Exemplary embodiments of the present invention may use an additional integrated circuit in mobile telephones having SIM cards regardless of telephone type. The additional integrated circuit may be adapted to telephone type (e.g. brand) by additional software transmitted from an external source, such as a remote server, in particular, at the request of the mobile telephone, and installed by the additional integrated circuit.

Exemplary embodiments of the present invention include a method for adapting a mobile telephone equipped with a SIM card for performing new functions (applications). When requested by the user, the user may be offered a menu of additional functions, including, for example, insertion of an additional integrated circuit in the telephone on a substrate having a contact interface connectable to the telephone. The additional integrated circuit may be subsequently adapted in the telephone by downloading and installing additional software to the telephone. The additional integrated circuit may use, upon connection to the telephone, preinstalled software (e.g. an operating system core). The operating environment of the telephone may be identified and the telephone may be prepared and initiated for transmission by the telephone through the mobile communications network, for example, in the form of a message requesting the remote server for additional software. In response to this communication, the server may send one message or several messages with additional software contained therein for the additional integrated circuit that downloads and installs the additional software.

Exemplary embodiments of the present invention may use a method for adapting a mobile telephone already equipped with a SIM card and an additional integrated circuit on a substrate having a contact interface connected to the telephone. Adaptation may include adapting the additional integrated circuit in the telephone by downloading and installing additional software sent by a remote server, for example, in the form of one or more messages containing additional software. In this way, the mobile telephone is able to receive the software for using the SIM additional integrated circuit and/or additional SIM cards through the mobile communications network.

The remote server may send a message containing the additional software to the telephone after it has received a message from that telephone with a request for additional software.

Accordingly, exemplary embodiments of the present invention may be able to allow a mobile telephone, or other device, operating within in a mobile communications network to be programmed to perform additional functions that could not otherwise be performed by the SIM cards inserted therein. This ability may be provided with the installation of an additional integrated circuit adaptable to the telephone upon installation of additional software on a substrate having a contact interface connected to the telephone. The mobile communications system may further include a server enabled to send messages containing additional software to the telephone to be downloaded to the additional integrated circuit. The SIM cards may be connected to the telephones through an additional integrated circuit enabled to download and install the additional software contained in the message of the server.

The server may be enabled to receive a request from a mobile telephone and send a message containing additional software to the telephone that has sent the request.

The additional integrated circuit may be adapted to prepare a message to be sent to the server by the telephone. In particular, the integrated circuit may be adapted to automatically prepare a message after it has been inserted in the telephone.

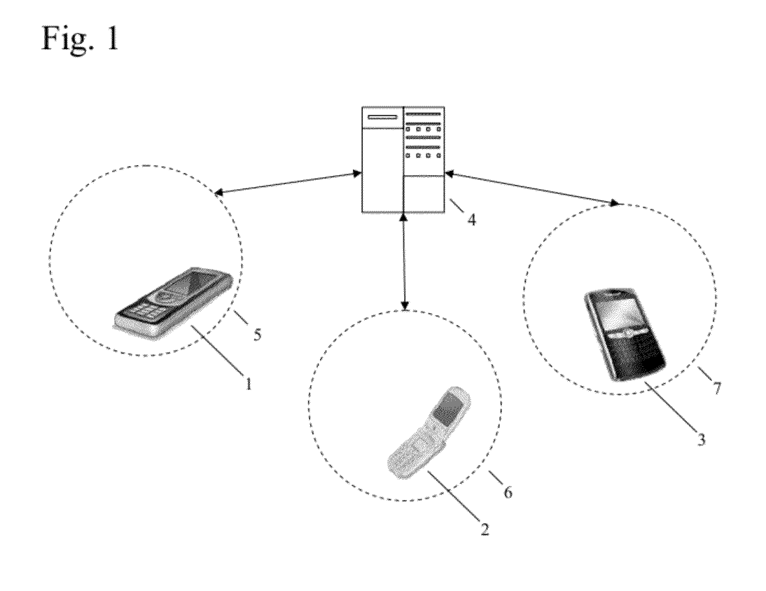

FIG. 1 is a diagrammatic view of a mobile communications system enabled to adapt a mobile telephone according to an exemplary embodiment of the present invention.

A mobile communications system shown in FIG. 1 includes mobile telephones 1, 2, and 3, and a remote server 4. Mobile telephones 1, 2, and 3 are within the operating ranges of radio networks 5, 6, and 7, and are each provided, in addition to the SIM cards inserted therein, with an additional integrated network on a substrate having a contact interface connected to the telephone. The additional integrated circuit is designed to enable the telephone to perform additional functions. The additional integrated circuit may first be adapted to the telephone after it has been inserted in the telephone and then the additional integrated circuit may alter the functionality of the telephone, for example, to add new functions or update existing functions, while the telephone is used (operated). The additional integrated circuit may be adapted by installing in it the additional software sent by server 4 to telephones 1, 2, and 3 in the form of, for example, SMS messages, GPRS messages, and/or USSD messages. The SIM cards may be connected to the telephones through the additional integrated circuit enabled to download and install additional software contained in the server message received by the telephone.

Connection of an additional integrated circuit together with a SIM card is described, for example, in Russian Patent No. 2,307,394 and U.S. Pat. No. 7,198,199 and No. 7,252,242, each of which are incorporated herein by reference.

The additional integrated circuit may be enabled to automatically prepare a message to be sent to the server by the telephone after it has been inserted in the telephone.

Server 4 may be capable of receiving and processing requests from mobile telephones 1, 2, and 3 and sending, in response to a request, messages containing additional software. Server 4 may also be capable of sending messages to telephones 1, 2, and 3 in accordance with its own program or on the operator's instructions.

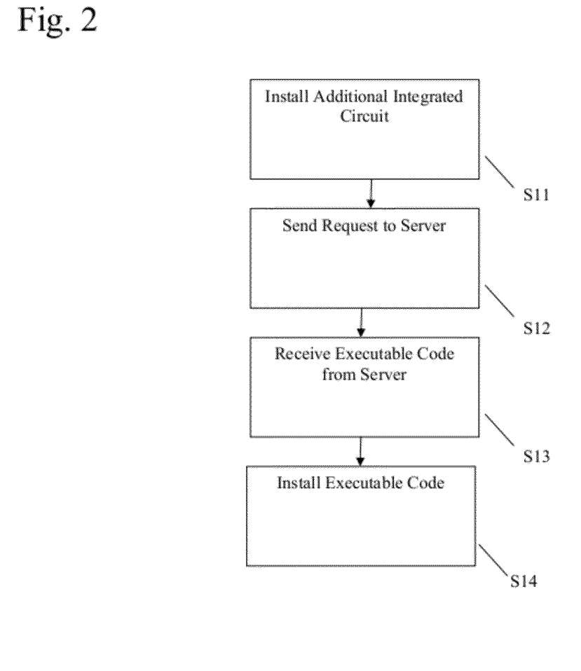

FIG. 2 is a flow chart illustrating an approach for adapting a mobile phone according to an exemplary embodiment of the present invention. First, an additional IC may be installed into the mobile phone (Step S11). Then, the mobile phone may utilize instructions incorporated into the additional IC to send a request to a server (Step S12). The request may be arranged in the form of a message such as an SMS, GPRS, USSD, or any other form of multimedia messaging service (MMS) message or data transfer. Next, the mobile phone may receive executable code from the server, which has sent the executable code in response to the request (Step S13). The executable code may be program code that is executable by the particular form of mobile phone. The executable code may be transferred in the form of a message such as those discussed above with respect to the request. The received executable code may then be installed in the mobile phone, for example, either to an existing memory of the mobile phone or to memory that is part of the additional integrated circuit (Step S14). The executable code, once installed, may provide additional functionality to the mobile phone, may update existing functionality or may otherwise provide new applications to the mobile phone. It should also be understood that in the method described above, and elsewhere in the instant disclosure, the use of a mobile phone is mentioned as an example, and exemplary embodiments of the present invention may be applied to other mobile devices which receive data over a wireless network, especially those mobile devices that are equipped with a subscriber identification card such ad a SIM card or the other such cards such as those mentioned above.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for adapting a mobile communications device equipped with a Subscriber Identification Module (SIM) card reader, comprising:
inserting an additional integrated circuit in the mobile communications device on a substrate having a contact interface connectable to the mobile communications device;
transmitting a request for additional software from the mobile communication device to a mobile communication server using programming preinstalled on the additional integrated circuit;
receiving, in response to the request, one or more message containing additional software for use by the additional integrated circuit; and
installing the received additional software within the mobile communications device or the additional integrated circuit.

2. The method of claim 1, wherein the mobile communications device is a mobile telephone.

3. The method of claim 1, wherein the mobile communications device is a portable computer, a smartphone, a personal digital assistant (PDA), a tablet computer, a portable media player (PMP), or a wireless modem.

4. The method as claimed in claim 1, wherein the request for additional software sent from the mobile communications device to the mobile communications server comprises one or more messages which include SMS messages, GPRS messages, USSD messages, or multimedia messaging service messages (MMS).

5. The method as claimed in claim 1, wherein the one or more message containing additional software for use by the additional integrated circuit include SMS messages, GPRS messages, USSD messages, or multimedia messaging service messages (MMS).

6. The method of claim 1, wherein the additional software for use by the additional integrated circuit includes an application.

7. The method of claim 1, wherein the SIM card reader is a card slot for receiving a SIM card, a Universal Integrated Circuit Card (UICC) containing a Universal Subscriber Identity Module (USIM), a Removable User Identity Module (R-UIM) card, or a PIM card.

8. A method for adapting a mobile communications device equipped with a SIM card reader, comprising:
executing instructions preinstalled on an additional integrated circuit integrated into the mobile communications device for generating and transmitting a request for additional software from a remote server; and
receiving and installing additional software from the remote server in response to the request, the additional software received in the form of one or more messages.

9. The method of claim 8, wherein the additional integrated circuit is removable from the mobile communications device.

10. The method of claim 8, wherein the mobile communications device is a mobile telephone.

11. The method of claim 8, wherein the mobile communications device is a portable computer, a smartphone, a personal digital assistant (PDA), a tablet computer, a portable media player (PMP), or a wireless modem.

12. The method as claimed in claim 8, wherein the remote server sends the one or more messages containing the additional software to the mobile communications device upon receipt of the request from the mobile communications device.

13. The method of claim 8, wherein the request for additional software sent from the mobile communications device to the mobile communications server and the one or more message containing the additional software each comprise one or more SMS messages, GPRS messages, USSD messages, or multimedia messaging service (MMS) messages.

14. A mobile communications system, comprising:
one or more mobile communications devices, each equipped with a SIM card reader and provided with an additional integrated circuit on a substrate having a contact interface connected to the mobile communications device via the SIM card reader, the additional integrated circuit including a slot for receiving a SIM card therein; and
a server configured to prepare and send messages containing additional software to the mobile communications devices to be downloaded and installed to the additional integrated circuit of the mobile communications devices,
wherein the additional integrated circuit is configured to enable the mobile communications devices to download and install the additional software sent from the server and contained in the messages.

15. The system of claim 14, wherein the mobile communications device is a mobile telephone, a portable computer, a smartphone, a personal digital assistant (PDA), a tablet computer, a portable media player (PMP), or a wireless modem.

16. The system as claimed in claim 14, wherein the server is configured to receive a message with a request from the mobile communications devices and to send a message containing the additional software to the mobile communications devices that have sent the request.

17. The system as claimed in claim 15, wherein the additional integrated circuit is capable of preparing a message to be sent by the mobile communications devices to the server.
